(19) United States
(12) Patent Application Publication
(10) Pub. No.: US 2006/0276180 A1
(43) Pub. Date: Dec. 7, 2006

(54) SYSTEM AND METHOD FOR PROVIDING AIRTIME OVERDRAFT PROTECTION

(76) Inventor: Coulter C. Henry JR., Marietta, GA (US)

Correspondence Address: PARKS KNOWLTON - C001, 1117 PERIMETER CENTER WEST, SUITE E402, ATLANTA, GA, 30338, US

(21) Appl. No.: 11/421,697

(22) Filed: Jun. 1, 2006

Related U.S. Application Data
(60) Provisional application No. 60/687,569, filed on Jun. 3, 2005.

(51) Int. Cl. H04Q 7/22

(52) U.S. Cl. 455/412.2; 455/405

(57) ABSTRACT

A system for providing airtime overdraft protection is provided. In an exemplary embodiment, the system monitors or checks airtime usage of a user and determines if the user has reached an airtime threshold value. If the airtime threshold value is reached, a notification is sent to the user. The user then has an option to purchase additional discount airtime minutes in response to the notification.

### CROSS-REFERENCE TO RELATED APPLICATION

This application claims priority to U.S. Application No. 60/687,569, filed Jun. 3, 2005, the entirety of which is incorporated herein by reference.

### FIELD OF THE INVENTION

The present invention relates generally to mobile devices, and more particularly to providing airtime overdraft protection for mobile devices.

### BACKGROUND OF THE INVENTION

Typically, a cellular phone customer subscribes to a service plan which provides a limited number of minutes for a flat fee. Typically, the service plan minutes are provided at a substantial discount then if the minutes are purchased separately. For example, the customer may have a service plan that provides 500 daytime minutes for a flat rate (e.g., $34.99/month). The customer is thus constrained by the number of airtime minutes he or she subscribes to each month. The service plan airtime minutes may be used for various purposes such as making outgoing calls, receiving incoming calls, and accessing customer service features via their cellular phone.

The customer may exceed their service plan airtime minutes, however, the cost per minute in excess of the service plan airtime minutes (i.e., “overage charge”) is usually quite high (e.g., $0.40 a minute for excess minutes). Often the customer will go over their service plan airtime minutes and be charged the higher rate without even knowing that they have “overdrawn” on their service plan airtime minutes. A first indication that they have overdrawn on their service plan airtime minutes may be provided when the customer receives their invoice for the period of time in which they are overdrawn. At this point, it is too late to change calling habits or purchase additional minutes at a discounted rate.

Therefore, there is a need for a system and method for providing airtime overdraft protection. There is a further need for a system and method for providing notification when service plan airtime minutes become limited.

### SUMMARY OF THE INVENTION

The present invention provides exemplary systems and methods for providing overdraft protection for a wireless communication account. According to one embodiment, a system according to the present invention comprises an account information unit configured to check the usage of the account for a billing period, compare the usage to a stored threshold value, and generate a notification to a subscriber associated with the account if the usage meets a criteria based on the threshold value.

The account information unit can be further configured to receive a special digit string sent from a mobile device. The account information unit can comprise a database that can be queried to determine if the account is authorized to use special digit string services. The special digit string can comprise an unstructured supplementary service data string or a short message service (SMS) message. The special digit string can begin with a “*” symbol and end with a “#” symbol. The account information unit can be a home location register (HLR). The usage can be an amount of allotted airtime minutes used by the account during a billing period, and the criteria can comprise the usage being greater than the threshold value. Alternatively, the usage can be an amount of allotted airtime minutes remaining for use during a billing period, and the criteria can comprise the usage being less than the threshold value. The notification can comprise a menu of options for purchasing additional minutes for the account.

The system can further comprise a service transfer point configured to receive the notification from the account information unit, a mobile switching center configured to receive the notification from the service transfer point, and a base station subsystem configured to receive the notification from the mobile switching center and send the notification to the mobile device. The mobile switching center can comprise a number analysis and translation module for analyzing the special digit string.

The system can further comprise a gateway configured to receive a response to the notification requesting the purchase of additional minutes, and a billing system configured to determine if the account is eligible to purchase additional minutes. The response can comprise a special digit string. The billing system can be configured to instruct the account information unit to add minutes to the account.

A method of providing overdraft notification services for a wireless communications subscriber account is disclosed that can include checking the usage of the account for a billing period, comparing the usage to a stored threshold value, and generating a notification to a subscriber associated with the account if the usage meets a criteria based on the threshold value. The method can also include receiving a special digit string sent from a mobile device associated with the account, the checking and comparing being performed in response to the receipt of the special digit string. A database can be queried to determine if the account is authorized to use special digit string services. The special digit string can comprise an unstructured supplementary service data string. The database queried can comprise a home location register.

The method can also include receiving a response to the notification requesting the purchase of additional minutes and determining if the account is eligible to purchase additional minutes. The method can further include instructing an account information unit to add minutes to the account. The method can also include sending a confirmation message to the subscriber associated with the account.

### BRIEF DESCRIPTION OF THE DRAWINGS

FIG. 1 is an exemplary GSM environment in which the present invention may be practiced;

FIG. 2 is an exemplary TDMA environment in which the present invention may be practiced.

FIG. 3 is flowchart of a method for providing user-initiated overdraft protection notification in accordance with one embodiment;

FIG. 4 is a flowchart of a method for providing automated overdraft protection notification in accordance with one embodiment; and

FIG. 5 is a flowchart of an exemplary method for providing the overdraft protection.

### DETAILED DESCRIPTION OF THE INVENTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as an illustration, specimen, model or pattern. The figures are not necessarily to scale and some features may be exaggerated or minimized to show details of particular components. In other instances, well-known components, systems, materials or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

The present invention provides systems and methods for providing airtime overdraft protection. In various embodiments, the airtime overdraft protection is provided via unstructured supplementary service data (USSD) or short message service (SMS) messaging. According to one embodiment, a mobile device user may enter a special digit string, which the system will interpret to be a request for airtime usage or balance. If the usage or balance exceeds a predetermined threshold, the system notifies the customer that they are approaching the end of their service plan minute allotment. In an alternative embodiment, the system monitors the customer's airtime usage, and sends a notification to the customer when the predetermined threshold is reached. In either embodiment, the customer then has an option to request purchase of additional discount minutes. In exemplary embodiments, the various requests may be sent via a special digit string using USSD and/or SMS messaging.

In exemplary embodiments, the special digit string is shorter than a typically phone number and corresponds to the requested information. In the present invention, the special (coded) digit string may start with a “*” and end with a “#” sign (hereinafter referred to as “*service”). This special digit string is a USSD string on a GSM network or an SMS string formatted to resemble a USSD string on a TDMA or CDMA network. Thus for example, a user may obtain the number of minutes available and used under their plan by entering “*MIN#” (i.e., “*646#“) and sending this coded digit string. Similarly, the user may check a balance on their plan by entering “*BAL#”. In an alternative embodiment, the coded digit string does not need to start with a “*” and/or end with a “#” sign, but may utilize other symbols, numbers, or combination of either symbols and/or numbers.

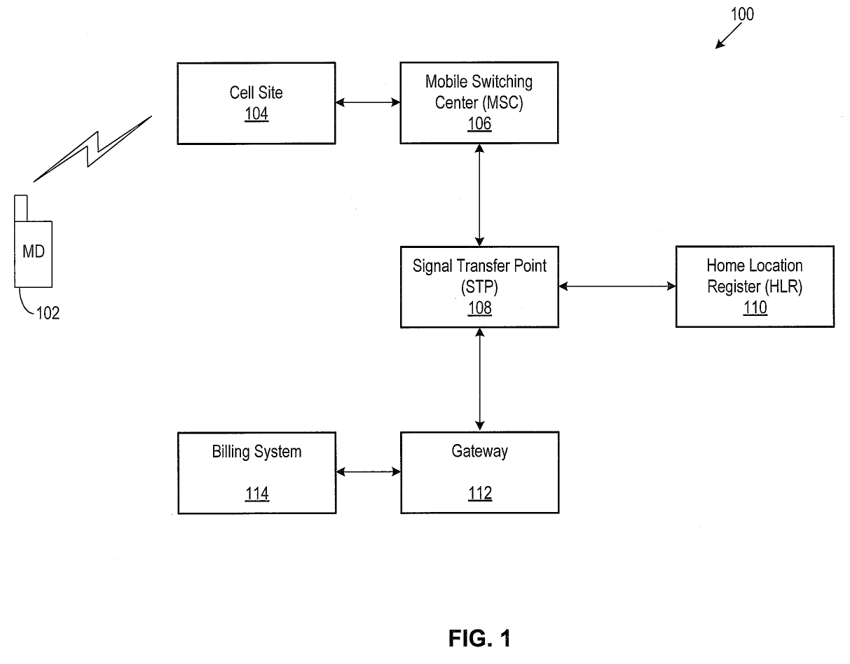

In a GSM environment, USSD messaging is utilized to allow transmission of information. The special digit string is recognized as a USSD code and is processed accordingly. Referring now to FIG. 1, a GSM environment 100 in which overdraft protection may be provided is shown. The illustrated GSM environment 100 includes a mobile device 102 in communication with a cell site 104. The cell site 104 can include a base station system (not shown) comprising one or more base station controllers in communication with one or more base transceiver stations, which are coupled to antennas for radiating transmitted signals and for receiving incoming signals. The cell site 104 is in communication with a mobile switching center (MSC) 106, which in turn is in communication with a signal transfer point (STP) 108. The STP is in communication with a home location register (HLR) 110 and a gateway 112. The gateway 112 provides access to a billing system 114. In this environment, a special digit string (e.g., the USSD string) is sent by a user from the mobile device 102 to the cell site 104, which relays the special digit string to the MSC 106. The GSM standard incorporates the use of USSD and as such translation or modification of the USSD string is not required. In the present example, the digit string is “*MIN#” (i.e., “*646#”), which represents a service request for the number of minutes used and available for the mobile device 102. In exemplary embodiments, the mobile device 102 is a cellular phone; however, the mobile device 102 may be any device capable of requesting customer service information.

The MSC 106 analyzes the special digit string and after analysis will recognize the digit string as a USSD string. The USSD string is then sent to the signal transfer point (STP) 108. In exemplary embodiments, the system utilizes Signaling System No. 7 (SS7) signaling protocol and architecture. As a result, the STP 108 performs routing functions for the GSM environment 100. The STP 108 routes the service request to the home location register (HLR) 110.

The HLR 110 comprises a database that manages mobile subscribers (i.e., the customers/users). The database can be a hierarchical, relational, and/or operational database. The database can contain data for each customer such as location of the mobile device 102, service plan subscription, user preferences, features, and the like. It should be understood that the HLR 110 may comprise a storage means for storing the database data. The storage means can comprise a plurality of storage devices internal or external to the HLR 110.

The HLR 110 also allows for transmission and reception of communications with the mobile device 102, and allows services to work in a similar way when the user is roaming outside of the user's home network. Thus, for example, if the user is outside of their home network (i.e., away from HLR 110), a visiting location register (VLR) transmits the user location to the HLR 110 which can then determine by which cell site the mobile device 102 is served. The VLR is typically located within an MSC; however, the VLR may also be located external to the MSC and be in communication with the MSC via SS7 signaling trunks.

In exemplary embodiments, the HLR 110 will verify that the customer subscribes to a plan that allows for processing the special digit string request (e.g., enabled with “*services”). Once verified, the HLR 110 then determines the number of airtime minutes subscribed to in the plan, the number of airtime minutes already used by the customer, and the number of remaining airtime minutes. That is, the HLR 110 queries its database requesting the customer's subscription data. The database receives the query, searches for the requested customer subscription data (e.g., if the customer is enabled with “*services”), and sends a query response to the HLR 110 with the requested customer data.

In addition to customer subscription data and customer preferences, the HLR database can include parameters such as an overdraft protection threshold value. This threshold value, when reached or exceed, will trigger generation of a notification to the customer that they are approaching the end of their service plan airtime minutes. The notification may be sent with the requested airtime information (which is requested via the “*MIN#” message) or after the requested airtime information has been sent. For example, if a user subscribes to a plan that provides 500 daytime minutes, the threshold value may be set to trigger a notification when the user has used 480 minutes. The threshold value may be any value prior to the service plan airtime minutes. In one embodiment, the threshold value is preset by a cellular service provider. In a further embodiment, the threshold value may be set or changed at any time by the customer. It should be understood that the threshold value may be any number of minutes.

The notification generated by the HLR 110 may be presented to the customers in various manners. In one exemplary embodiment, the HLR 110 sends the notification to the STP 108. The STP 108 receives the notification and routes it to the MSC 106, which in turn forwards the notification to the mobile device 102. The notification may be in the form of a text message, SMS message, a menu of minute options, or any combination thereof, and the like. In exemplary embodiments, the menu option will provide the customer with a series of different additional minute options. For example, the menu option may ask the customer to choose between adding 20 minutes, 40 minutes, 60 minutes, no minutes, or a custom amount of minutes which the user may enter into their mobile device 102. The notification can be presented to the customer via a display (not shown) on the mobile device 102. The notification can also comprise a “call” to the mobile device to notify the user to check their text messages or the “call” can simply present the notification to the user.

In further embodiments, the notification may comprise a voicemail or a particular tone emitted by a speaker (not shown) on the mobile device 102. For example, a certain ring tone may sound when the threshold value is exceeded. In yet further embodiments, the notification may be sent, in addition or alternatively, to a device other than the mobile device 102 (e.g., e-mail to the customer's personal computer, call or voicemail to a POTS device, etc.).

If the customer responds with a request to add additional minutes to their plan, then the request is forwarded through the gateway 112 to the billing system 114. In the present example, the gateway 112 is a USSD gateway. The billing system 114 can be in communication with the gateway 112 via a wired or wireless network such as, but not limited to, a local area network (LAN, a metropolitan area network (MAN), a wide area network (WAN), or any other type network known to those skilled in the art.

The billing system 114 reviews the customer's billing information and decides if the request for additional minutes may be granted. For example, if the customer is past due on their account, the billing system 114 may decide not to grant the request for additional minutes until the customer becomes current on their account. If the request is granted, then the billing system 114 adds the additional minutes and charges the amount for the additional minutes to the customer's account. In one embodiment, a message may be sent from the billing system 114 to the HLR 110 to update the number of discount airtime minutes (i.e., bulk airtime minutes purchased at a discount). In a further embodiment, a confirmation message may be generated and sent (e.g., by the billing system 114) to the mobile device 102 to indicate that the additional minutes have been added to their account. The message can comprise, for example, a USSD message, an SMS message, a voice message, MMS message, and the like. The message can be sent via any means.

It should be noted that the illustrated GSM environment 100 of FIG. 1 is exemplary. Alternative embodiments may comprise more, less, or other elements. For example, the billing system 114 may be part a server farm which houses a plurality of databases containing customer information. The server farm can comprise at least one server and at least one database of customer and customer service information which can be queried by the at least one server to find requested customer information.

It is desirable to have USSD-like technology in non-GSM networks such as TDMA or CDMA networks where USSD is not supported nor are any other functions available for supporting a similar function. TDMA refers generally to a class of technologies including IS-54 and IS-136 where the SS7 networked transport is principally TIA-41/IS-41. CDMA refers generally to a class of technologies including CDMA2000, IS-95, and IS-2000 where the SS7 network transport is principally TIA-41/IS-41. Therefore, in exemplary embodiments, the USSD-like technology may be enabled via the use of IS-41/SS7 communication language.

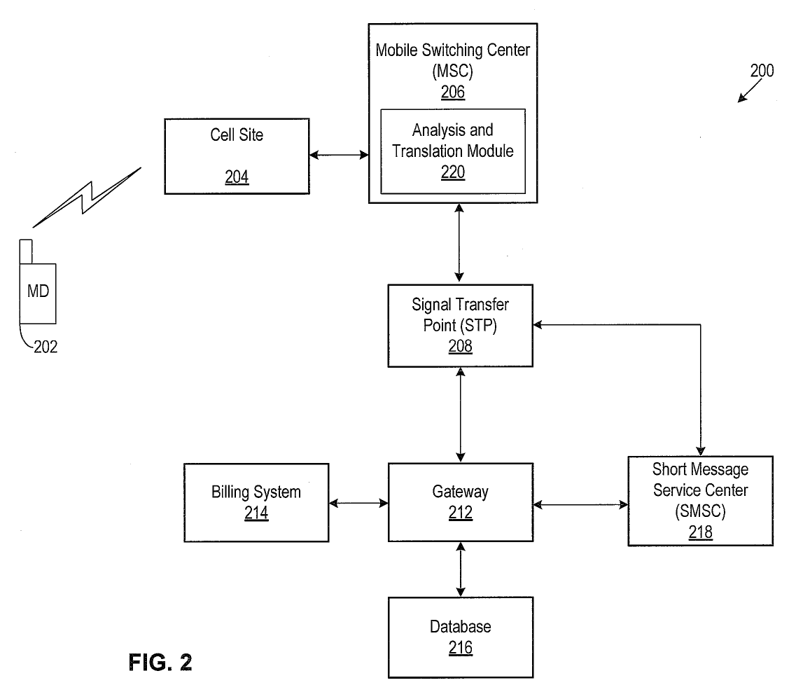

Referring to FIG. 2, an exemplary TDMA environment 200 in which the present invention may be practiced is provided. The present invention may further be practiced on a similar CDMA environment. The illustrated TDMA environment 200 includes a mobile device 202 in communication with a cell site 204. The cell site 204 can include a base station system (not shown) comprising one or more base station controllers in communication with one or more base transceiver stations, which are coupled to antennas for radiating transmitted signals and for receiving incoming signals. The cell site 204 is in communication with an MSC 206, which in turn is in communication with an STP 208. The STP 208 is in communication with a gateway 212 and a short message service center (SMSC) 218. The gateway 212 provides access to a database 216, a billing system 214, and the SMSC 218. In the TDMA environment 200, a special digit string (e.g., a digit string similar to a USSD string in the GSM environment) is sent by a user from the mobile device 202 to the cell site 204, which relays the special digit string to the MSC 206. In exemplary embodiments, the mobile device 202 is a cellular phone; however, the mobile device 202 may be any device capable of requesting customer service information.

The exemplary MSC 206 is configured with a number analysis and translation module 220 configured for analyzing the special digit string and translating it into a format distinguishable to the MSC 206 and to the other network elements. Once a special digit string is received, the MSC 206 uses the number analysis and translation module 220 and a corresponding table to analyze the dialed digit string and translates this digit string to another functionality (e.g., to a long digit string representing a request for information). Advantageously, the user only needs to dial a short coded digit string to access some functionality instead of a seven, eight, eleven, or any other number digit number resulting in simplicity, speed of dialing, and less likelihood of dialing errors.

In the present example, if the user dials “*646#,” the number analysis and translation module 220 will analyze and translate the digit string. According to exemplary embodiments, the digit string will be translated into a service request (e.g., to access and send cell usage minute information to the requesting mobile device 202). In some embodiments, the analysis and translation performed by the number analysis and translation module 220 may evaluate the digit string and parse, add, delete, and/or replace digits in the dialed digit string before forwarding the digit string. For example, in one embodiment, the number analysis and translation module 220 will translate the special digit string into a seven digit number (e.g., a phone number), a ten digit number (e.g., an area code and a phone number), or any other number of digit numbers for contact with, for example, a customer service representative and/or an automated customer service system. Subsequently, the user can communicate with the customer service representative and/or the automated customer service system. Alternatively, or in addition, the customer service representative and/or the automated customer service system may trigger a service request (e.g., to access and send cell usage minute information to the requesting mobile device 202).

The MSC 206 is also capable of applying special treatment to digit strings such as, for example, applying an IS-41C call treatment origination request. The origination request is used to validate mobile outbound calls and contains many elements of useful information such as a mobile directory number, serving system (needed to route results back to the requesting mobile device 202), a network's identification of the mobile device 202, serving cell ID, and electronic serial number (ESN).

After analysis and translation, the service request is sent to the STP 208. In exemplary embodiments, the system utilizes Signaling System No. 7 (SS7) signaling protocol and architecture. As a result, the STP 208 performs routing functions for the TDMA environment 200. The STP 208 routes the service request to the gateway 212. In the present example, the gateway 212 may comprise a service control point (SCP). The SCP provides an interface to database(s) 216 and other components. It is contemplated that the SCP or SCP/gateway may be combined with the STP 208.

The database(s) 216 can be configured to manage mobile subscribers (i.e., the customers/users). The database(s) 216 can be a hierarchical, relational, and/or operational database. The database(s) can contain data for each customer such as location of the mobile device 202, service plan subscription, user preferences, features, and the like.

Thus, for example, all subscription data for each customer such as location of the mobile device 202, service plan subscription, user preference, features, and the like may be stored in the database(s) 216. Essentially, the gateway 212 and database(s) 216 function as an equivalent to the home location register 110 (FIG. 1) in the GSM environment. It is contemplated that at least one HLR and at least one VLR can be implemented in addition, or as an alternative to the SCP and database(s) 216.

In exemplary embodiments, the system will verify that the customer subscribes to a plan that allows for processing the special digit string request (e.g., enabled with “*services”). Once verified, the number of airtime minutes subscribed to in the plan, the number of airtime minutes already used by the customer, and the number of remaining airtime minutes are determined.

The requested airtime minute information is then assembled into a customer service response. In exemplary embodiments, the customer service response is in a form of a short messaging service (SMS) message. The SMS message is forwarded to the short message service center (SMSC) 218. The customer service response is, in exemplary embodiments, sent via short message peer-to-peer (SMDPP) to the SMSC 218. It is contemplated, however, that any applicable protocol can be implemented to accomplish this task.

The SMSC 218 is an access point for the customer service response. In the present embodiment, the SMSC 218 receives the customer service response and reformats the customer service response for delivery to the mobile device 202. For example. The SMSC 218 may reformat the response into an IS-41C SMDPP message. The customer service response is sent to the STP 208. The STP 208 routes the customer service response to the MSC 206. The MSC 206 then forwards the customer service response to the cell site 204, which in turn sends the customer service response to the mobile device 202.

In addition to customer subscription data and customer preferences, the database(s) 216 can include parameters such as an overdraft protection threshold value. This threshold value, when reached or exceed, will trigger generation of a notification to the customer that they are approaching the end of their service plan airtime minutes. The notification may be sent with the requested airtime information (which is requested via the “*MIN#” message) or after the requested airtime information has been sent. For example, if a user subscribes to a plan that provides 500 daytime minutes, the threshold value may be set to trigger a notification when the user has used 480 minutes. The threshold value may be any value prior to the service plan airtime minutes. In one embodiment, the threshold value is preset by a cellular service provider. In a further embodiment, the threshold value may be set or changed at any time by the customer. It should be understood that the threshold value may be any number of minutes.

The notification can be sent with the requested airtime information or after the requested airtime information has been sent. The manner for transmitting the notification is similar to that for transmitting the requested information described above.

If the customer responds with a request to purchase additional airtime minutes to their service plan, then the request is forwarded through the gateway 212 to the billing system 214. The billing system 214 can be in communication with the gateway 212 via a wired or wireless network such as, but not limited to, a local area network (LAN), a metropolitan area network (MAN), a wide area network (WAN), or any other type of network known to those skilled in the art. The billing system 214 reviews the customer's billing information and decides if the request for additional minutes may be granted. For example, if the customer is past due on their account, the billing system 214 may decide not to grant the request for additional minutes until the customer becomes current on their account. If the request is granted, then the billing system 214 adds the additional minutes and charges the amount for the additional minutes to the customer's account. In one embodiment, a message may be sent from the billing system 214 to the database(s) 216 to update the number of discount airtime minutes (i.e., bulk airtime minutes purchased at a discount). In a further embodiment, a confirmation message may be generated and sent (e.g., by the billing system 214) to the mobile device 202 to indicate that the additional minutes have been added to their account. The message can comprise, for example, a USSD message, an SMS message, a voice message, MMS message, and the like. The message can be sent via any means.

It should be understood that the embodiments described with respect to the illustrated TDMA environment 200 of FIG. 2 are exemplary and other standards and as such, alternative embodiments may include more, less and/or other elements and/or utilize different air interface, signaling, and other telecommunications protocols. For example, the foregoing description can be applied to a CDMA environment. Further, the SMSC 218 may be optional, and the return message may be formatted or converted into other types of formats by the gateway 212.

While the embodiments of FIGS. 1 and 2 have been described with reference to overdraft protection triggered by a service request from the user (i.e., mobile device 102 or 202), alternatively, the system may monitor a customer's airtime usage and send the notification without any user intervention. Thus, for example, the billing systems 114 (FIG. 1) or 216 (FIG. 2), the home location register 110 (FIG. 1) in the GSM environment or a processing device coupled to the database(s) 216 (FIG. 2) in the TDMA environment will continuously or periodically check airtime usage for each customer. In further embodiments, the checks may occur at the beginning, during, or end of a phone call on the mobile device 102 (FIG. 1) or 202 (FIG. 2) or at any other event driven time (e.g., after a service request, after checking voicemail or text message, etc.). In yet a further embodiment, the customer may request the system provide a check (for airtime balance, overdraft protection, or both) at a predetermined time (e.g., the 15^{th} of every month).

If the check results in airtime usage at or beyond the threshold value, then an automated notification is sent to the customer of the mobile device 102 or 202. The automated notification can be in any form, such as a SMS message, a menu of minute options, a voicemail or text message, dial tones, etc. For example, a particular tone may sound if a customer reaches their threshold value while conducting a phone call. In this embodiment, the customer is not interrupted during the phone call, but is still notified of the limited amount of airtime minutes remaining on their service plan. Accordingly, the customer may end the call within the remaining airtime minutes and initiate a process to purchase additional discount airtime minutes. In the same example, a text message or voicemail may be sent to the customer during the initial phone call, which the customer can retrieve upon finishing the initial phone call.

Similar to the notification described above in the user initiated embodiments, the automated notification may provide a notice that the customer's service plan airtime minutes are approaching their maximum usage. Additionally, the notification may also provide the customer a mechanism to initiate purchase of additional discount airtime minutes. Thus, the customer may be provided an option/drop-down menu on a display of their mobile device 102 or 202, for example, to purchase a specific number, a custom number, or no airtime minutes.

In another embodiment, the mobile device 102 or 202 will receive the notification and await the user's response regarding the specific amount of discount airtime minutes they would like to purchase. For example, the customer may press “20 enter” or “20#” to purchase 20 additional discount minutes at a prompt.

In further embodiments, the mobile device 102 or 202 will only receive the notification. If the customer desires to purchase additional discount airtime minutes, the customer then initiates the purchase process. In one embodiment, the customer may send another special digit string coded to represent a request to purchase the additional airtime minutes. For example, the customer may enter a * service command (e.g., *100#) to purchase a preset amount of discount airtime minutes (e.g., 20 minutes). The present amount may be determined by the cellular service provider or by the customer.

In an alternative embodiment, additional parameter functionality may be utilized. USSD (in GSM), SMS, or simulated-USSD (in TDMA/CDMA) may implement additional parameters by separating the parameters with a “*”, and terminating the request with a “#”. Thus, in a further embodiment, the *service command may represent a request to purchase the additional airtime minutes and an amount to be purchased. For example, the customer may enter “*100*40#” to indicate that they would like to purchase additional discount airtime minutes (i.e., “*100”), and they would like to purchase 40 minutes (“*40”). In this manner, any number of additional discount airtime minutes may be purchased by the customer. It should be noted that the special digit strings, “*100#” and *100*number of minutes#”, are exemplary and that the special digit string denoting purchase of additional minutes may comprise any combination of numbers and symbols.

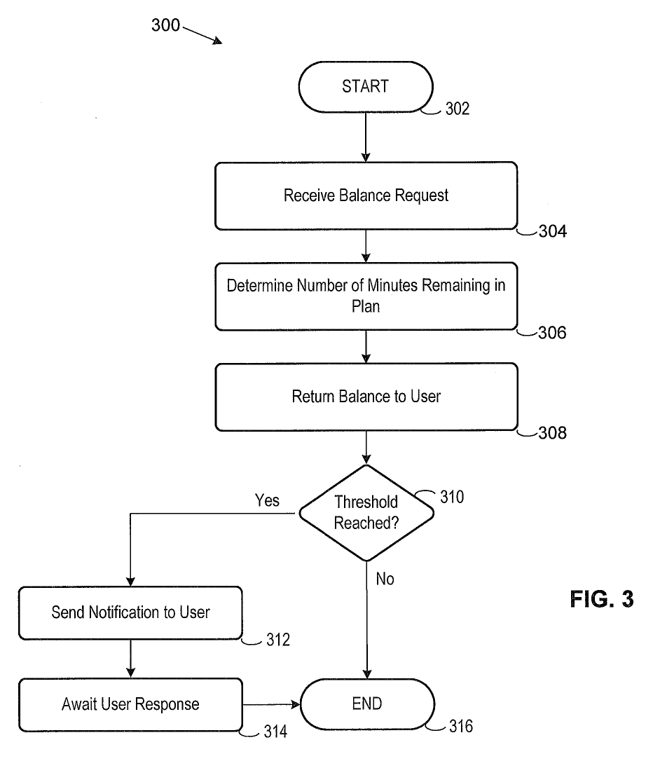

Referring now to FIG. 3, a flowchart 300 of an exemplary method for providing user-initiated overdraft protection notification in accordance with one embodiment is shown. The exemplary method begins at step 302, and proceeds to step 304, where a balance request is received by the mobile switching center 106 (FIG. 1) or 206 (FIG. 2) and forwarded through the signal transfer point 108 (FIG. 1) or 208 (FIG. 2). In the GSM environment, the balance request may be in the form of a USSD message, which is recognized by the MSC 106. Alternatively, an analysis and translation module 220 (FIG. 2) in the TDMA environment may translate a special digit string received from the mobile device 202 (FIG. 2) to determine that the special digit string represents a balance request.

In step 306, a number of discount airtime minutes remaining in the service plan is determined. Thus, a home location register 110 (FIG. 1) in the GSM environment will determine the number of discount airtime minutes used, subscribed to, and still available. In the TDMA environment, the balance request is forwarded through the gateway 212 (FIG. 2) to database(s) 216 (FIG. 2) where the same airtime minute determination is made by a coupled processor or the billing system 214 (FIG. 2). It is contemplated, however, that an HLR may also be utilized in the TDMA environment. The balance (i.e., remaining, available discount airtime minutes) is then returned to the customer in step 306.

In step 308, the system determines if a threshold value in used airtime minutes has been reached or exceeded. This determination may be made by the HLR 110, the billing system 114 (FIG. 1) or 216 (FIG. 2), a processor coupled to database(s) 216, or any other processing device in the system. If the threshold value has not be reached or exceeded, then the method proceeds to step 316 and the method ends. Alternatively, if the threshold has been reached or exceeded, then a notification is sent to the customer in step 312. The notification may comprise a SMS message, a text message, a voice message, a ring tone, or any other form of notification compatible with the mobile device 102 or 202 or associated devices (e.g., e-mail to a customer's personal computer).

In one embodiment, the notification only informs the customer that they are approaching the end of their discount airtime minute usage. In this embodiment, the customer then needs to initiate a process to purchase additional discount airtime minutes.

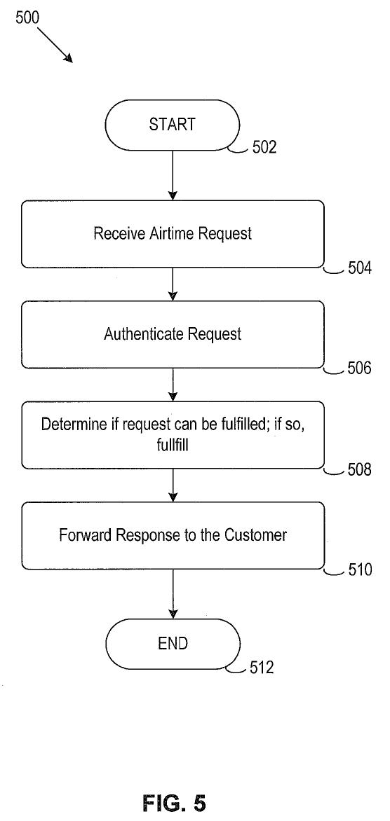

In optional step 314, the system awaits a user response to the notification. In this embodiment, the notification informs the customer of the approaching end of discount airtime minute usage and provides the customer a mechanism to purchase additional discount airtime minutes. For example, a menu may be provided from which the customer may select the amount of discount airtime minutes they would like to purchase, or a field may be provided on a display of the mobile device 102 or 202 where the customer may enter a number of minutes to purchase. The purchase process will be described in further detail in connection with FIG. 5 below.

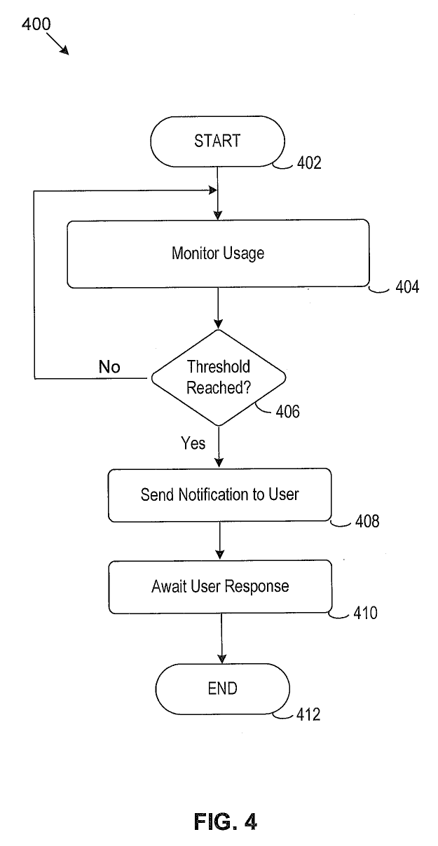

Referring now to FIG. 4, an exemplary flowchart 400 of an exemplary method for providing automated overdraft protection notification is shown. The exemplary method begins at step 402 and proceeds to step 402, where the system periodically or continuously monitors airtime usage. The monitoring may also be event triggered. For example, the system may perform a check when a customer initiates a call or ends a call. In various embodiments, the home location register 110 (FIG. 1), the billing system 114 (FIG. 1) or 216 (FIG. 2), a processor coupled to database(s) 216 (FIG. 2), or any other processing device in the system may perform the monitoring.

The system then determines, in step 406, if an airtime minute usage threshold value has been reached or exceeded. This determination may be made by the HLR 110, the billing system 114 (FIG. 1) or 216 (FIG. 2), the processor coupled to database(s) 216, or any other processing device in the system. If the threshold value has not be reached or exceeded, then the system continues to monitor usage (returning to step 404).

Alternatively, if the threshold has been reached or exceeded, then a notification is sent to the customer in step 408. The notification can comprise a SMS message, a text message, a voicemail, a ring tone, or any other form of notification compatible with the mobile device 102 (FIG. 1) or 202 (FIG. 2). In one embodiment, the notification only informs the customer that they are approaching the end of their discount airtime minute usage. In this embodiment, the customer then needs to initiate a process to purchase additional discount airtime minutes.

In optional step 410, the system awaits a user response to the notification. In this embodiment, the notification provides the customer a mechanism to purchase additional discount airtime minutes. For example, a menu may be provided from which the customer may select the amount of discount airtime minutes they would like to purchase, or a field may be provided on a display of the mobile device 102 or 202 where the customer may enter a number of minutes to purchase. The purchase process will be described in further detail in connection with FIG. 5 below.

Referring now to FIG. 5, a flowchart 500 of an exemplary method for providing the overdraft protection is shown. The exemplary method begins at step 502 and proceeds to step 504, where the system receives the airtime purchase request. For example, the MSC 106 (FIG. 1) or 206 (FIG. 2) receives the purchase request and forwards the purchase request to the STP 108 (FIG. 1) or 208 (FIG. 2). In one embodiment, the purchase request is a special digit string, such as “*100#” (e.g., representing a request to purchase a preset number of minutes) or, for example, “*100*40#” (e.g., representing a request to purchase an additional 40 minutes). In the GSM environment 100, the special digit string is recognized as an USSD message and forwarded as a service request to the home location register 110 (FIG. 1). In the TDMA environment 200, the special digit string is translated by the analysis and translation module 220 (FIG. 2) prior to forwarding the request to the signal transfer point 208.

The request is authenticated in step 506. Authentication can include verifying that the customer subscribes to a service plan which allows for the purchase of additional discount airtime minutes, verifying that the customer is current on their account, and the like. The authentication may be performed at the HLR 110, the billing system 114 (FIG. 1) or 216 (FIG. 2), or a processor coupled to the system. It should be noted that step 506 may be optional.

In step 508, the system determines if the purchase request can be fulfilled. In one embodiment, the billing system 114 or 216 determines if minutes can be added to the customer's plan. Furthermore, the billing system 114 or 216 may determine if the customer has set up a method for paying for the additional airtime minutes. For example, if the customer pays for their service plan via a credit card, the billing system 114 or 216 determines if the credit card has a valid expiration date and if added charges for the additional airtime minutes are approved for the credit card. If the purchase request can be fulfilled, then the additional discount airtime minutes are added to the customer's account.

A response is generated and forwarded to the customer in step 510. The response will confirm whether or not the request number of additional airtime minutes has been added to the customer account. The response can comprise an SMS message, a text message, a voice message, and the like. For example, the response may appear on the mobile device 102 or 202 like a normal SMS message. Thus, the user will receive an alerting tone that a message is available, and may access the message through normal operations (e.g., pushing a single button to read the requested response).

In further embodiments, enhanced automated customer services may be developed based on an “access code+optional parameter” concept. For example, a user may enter “*00#” on their mobile device 102 or 202 as an initial purchase request. Once received, the response may indicate availability (e.g., via SMS or USSD messaging) of preset numbers of airtime minutes the customer may purchase such as “*20#” for 20 minutes, “*40#” for 40 minutes, and so forth.

The law does not require and it is economically prohibitive to illustrate and teach every possible embodiment of the present claims. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

What is claimed is:

1. A system for providing overdraft notification services for a wireless communications subscriber account associated with a mobile device comprising:
an account information unit configured to:
check the usage of the account for a billing period;
compare the usage to a stored threshold value; and
generate a notification to a subscriber associated with the account if the usage meets a criteria based on the threshold value.

2. The system of claim 1, wherein the account information unit is further configured to receive a special digit string sent from a mobile device associated with the account.

3. The system of claim 2, wherein the account information unit comprises a database, the account information unit being configured to query the database to determine if the account is authorized to use special digit string services.

4. The system of claim 2, wherein the special digit string comprises an unstructured supplementary service data string.

5. The system of claim 2, wherein the special digit string comprises a short message service (SMS) message.

6. The system of claim 2, wherein the special digit string begins with a “*” symbol and ends with a “#” symbol.

7. The system of claim 1, wherein the usage is an amount of allotted airtime minutes used by the account during a billing period, and the criteria comprises the usage being greater than the threshold value.

8. The system of claim 1, wherein the usage is an amount of allotted airtime minutes remaining for use during a billing period, and the criteria comprises the usage being less than the threshold value.

9. The system of claim 1 wherein the notification comprises an email sent to an email address associated with the account.

10. The system of claim 1 wherein the notification comprises a menu of options for purchasing additional minutes for the account.

11. The system of claim 1, further comprising:
a service transfer point (STP) configured to receive the notification from the account information unit;
a mobile switching center (MSC) configured to receive the notification from the STP;
a base station subsystem (BSS) configured to receive the notification from the MSC and send the notification to the mobile device.

12. The system of claim 2, further comprising:
a base station subsystem (BSS) configured to receive the special digit string from the mobile device;
a mobile switching center (MSC) configured to receive the special digit string from the BSS, and analyze the special digit string;
a service transfer point (STP) configured to receive the special digit string from the mobile switching center and route the special digit string to the account information unit, the account information unit comprising a home location register (HLR).

13. The system of claim 2, wherein the special digit string comprises a request for the amount of allotted minutes used during a billing period.

14. The system of claim 13, wherein the special digit string comprises “*MIN#” .

15. The system of claim 2, wherein the special digit string comprises a request for the amount of allotted minutes remaining in a billing period.

16. The system of claim 15, wherein the special digit string comprises “*BAL#”.

17. The system of claim 1, further comprising:
a gateway configured to receive a response to the notification requesting the purchase of additional minutes;
a billing system configured to determine if the account is eligible to purchase additional minutes.

18. The system of claim 17, wherein the response comprises a special digit string.

19. The system of claim 18, wherein the special digit string begins with a “*” and ends with a “#”.

20. The system of claim 19, wherein the special digit string comprises a number of minutes to be purchased preceded by “*” and ending with “#”.

21. The system of claim 17, wherein the billing system is further configured to instruct the account information unit to add minutes to the account.

22. The system of claim 21, wherein the billing system is further configured to send a confirmation message to the subscriber associated with the account.

23. The system of claim 21, wherein the account information unit is further configured to send a confirmation message to the subscriber associated with the account.

24. The system of claim 17 wherein the response received comprises a choice made from a menu of the notification.

25. A method of providing overdraft notification services for a wireless communications subscriber account associated with a mobile device comprising:
checking the usage of the account for a billing period;
comparing the usage to a stored threshold value; and
generating a notification to a subscriber associated with the account if the usage meets a criteria based on the threshold value.

26. The method of claim 25, further comprising:
receiving a special digit string sent from a mobile device associated with the account, the checking and comparing being performed in response to the receipt of the special digit string.

27. The method of claim 25, wherein the usage is an amount of allotted airtime minutes used by the account during a billing period, and the criteria comprises the usage being greater than the threshold value.

28. The method of claim 25, wherein the usage is an amount of allotted airtime minutes remaining for use during a billing period, and the criteria comprises the usage being less than the threshold value.

29. The method of claim 25, further comprising:
sending the notification from an account information unit to a service transfer point (STP);
forwarding the notification from the STP to a mobile switching center (MSC);
forwarding the notification from the MSC to a base station subsystem (BSS); and
forwarding the notification from the BSS to the mobile device.

30. The method claim 26, further comprising:
receiving the special digit string from the mobile device at a base station subsystem (BSS);
forwarding the special digit string from the BSS, to a mobile switching center (MSC);
analyzing the special digit string at the MSC;
routing the special digit string from the MSC to a service transfer point (STP); and
routing the special digit string to a home location register (HLR).
